(19) United States
(12) Patent Application Publication
(10) Pub. No.: US 2023/0221566 A1
(43) Pub. Date: Jul. 13, 2023

(54) VR HEADSET WITH INTEGRATED THERMAL/MOTION SENSORS

(71) Applicant: Sony Interactive Entertainment Inc., Tokyo (JP)

(72) Inventor: Sean Whitcomb, San Mateo, CA (US)

(21) Appl. No.: 17/571,468

(22) Filed: Jan. 8, 2022

(51) Int. Cl. G02B 27/01; G06F 3/01; A63F 13/21

(52) U.S. Cl. CPC G02B 27/0176; G06F 3/011; A63F 13/21

(57) ABSTRACT

A virtual reality (VR) headset wearable by a computer game player includes integrated thermal and/or motion sensors on the exterior of the VR headset to detect the presence of others in immediate proximity to the player, sending a signal to the player's view screen, warning the player of potential collisions with others.

### FIELD

The present application relates generally to virtual reality (VR) headsets with integrated thermal/motion sensors.

### BACKGROUND

As recognized herein, wearing a VR headset transports players to other (virtual) worlds, immersing them in an experience using sight and sound. Players experience the virtual world, while still physically in the real world.

### SUMMARY

As understood herein, in some cases, players wearing VR headsets are not alone. They may be in shared spaces with pets, children, or even other players.

Accordingly, an assembly includes at least one headset that in turn includes at least one head mount wearable by a player and at least one display on the head mount for presenting virtual reality (VR) images under control of at least one processor. The assembly also includes at least one heat and/or motion sensor providing signals to the processor for presenting at least one indication on the headset of a source of heat and/or motion external to the headset.

In an example embodiment, one and only one heat and/or motion sensor is rotatably mounted on the headset. In another example embodiment, plural heat and/or motion sensors are stationarily mounted on the headset.

In some implementations the indication can include a tactile indication such as heat. In addition, or alternatively, the indication can include activating a lamp on the headset. In addition, or alternatively, the indication can include an image of the object presented on the display. In addition, or alternatively, the indication can include an image of a track of the object presented on the display.

In other examples the at least one sensor is distanced from the headset and oriented to provide signals to the processor representing the source of heat and/or motion external to the headset when the source is between the at least one sensor and the headset, and otherwise not provide signals to the processor representing the source of heat and/or motion external to the headset when the at least one sensor is between the source and the headset.

In another aspect, a method includes receiving a signal from an infrared sensor, and based at least in part on the signal, presenting on at least one virtual reality (VR) headset an indication of a source of the signal.

In another aspect, a device includes at least one computer storage that is not a transitory signal and that in turn includes instructions executable by at least one processor to receive a signal from a thermal and/or motion sensor, and based at least in part on the signal present an indication on at least one virtual reality (VR) headset of an object that is external to the headset and that is a source of the signal.

In example embodiments, the instructions may be executable to present the indication responsive to the signal indicating a source having a threshold size, and otherwise not present the indication. In addition, or alternatively, the instructions may be executable to present the indication responsive to the signal having a threshold signal strength, and otherwise not present the indication. In addition, or alternatively, the instructions may be executable to present the indication responsive to the signal indicating a source having a threshold trajectory, and otherwise not present the indication.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates a perspective view of an example headset;

FIG. 3 is a bottom view of the headset shown in FIG. 2, schematically showing internal components;

FIG. 4 illustrates an alternate headset;

FIG. 5 illustrates an example presentation on a display of the headset;

FIG. 6 illustrates example logic in example flow chart format consistent with present principles;

FIG. 7 illustrates an alternate system;

FIG. 8 illustrates example logic in example flow chart format for training a machine learning model consistent with present principles; and

FIG. 9 illustrates additional example logic in example flow chart format for training a machine learning model consistent with present principles.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

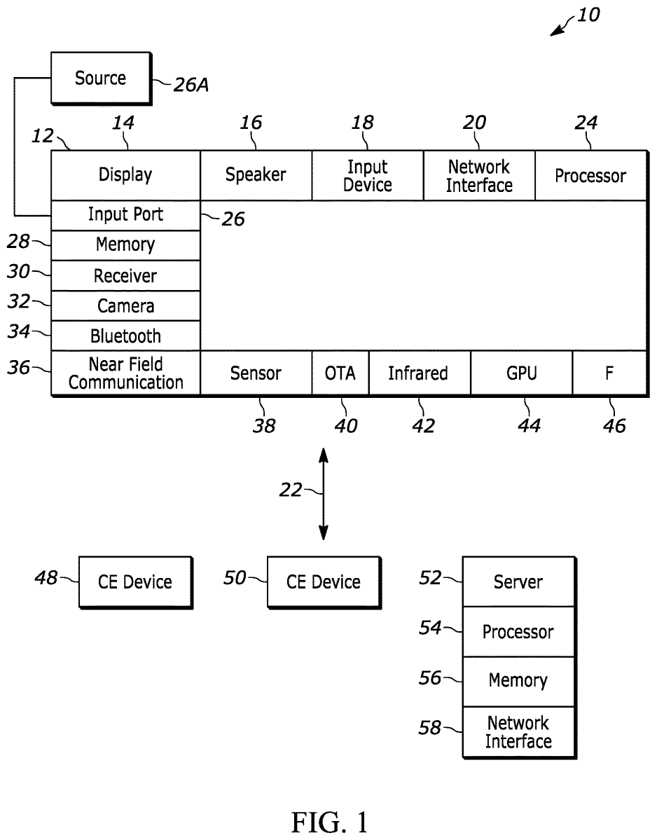

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown in FIG. 1. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage mediums 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24. The component 30 may also be implemented by an inertial measurement unit (IMU) that typically includes a combination of accelerometers, gyroscopes, and magnetometers to determine the location and orientation of the AVD 12 in three dimension or by an event-based sensors.

Continuing the description of the AVD 12, in some embodiments the AVD 12 may include one or more cameras 32 that may be a thermal imaging camera, a digital camera such as a webcam, an event-based sensor, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 (e.g., a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command)) that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

Still referring to FIG. 1, in addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other devices of FIG. 1 over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown in FIG. 1 or nearby.

The components shown in the following figures may include some or all components shown in FIG. 1. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Support vector machines (SVM) and Bayesian networks also may be considered to be examples of machine learning models.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

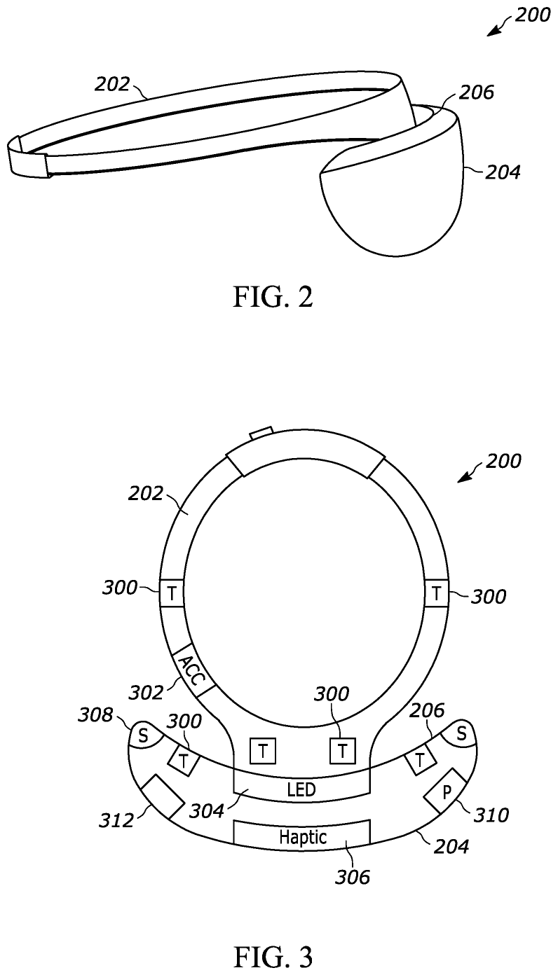

FIGS. 2 and 3 show a headset 200 that may incorporate appropriate components of any of the CE devices described above, as amplified below. The headset 200 may include a headband or strap 202 configured to be worn on a person's head and a head-mounted display (HMD) 204 attached to the head strap for placement of a display portion 206 on the inside or posterior surface of the HMD in front of the eyes of a wearer. Together, the headband or strap 202 and HMD 204 may establish a HMD assembly.

FIG. 3 best shows that one or more thermal and/or motion sensors 300 may be mounted on the headband or strap 202 and/or HMD 204. The sensors 300 can be positioned in any desired location anticipated to provide signals representing mobile sources of heat and in particular living beings such as animals or people. Only a single sensor 300 may be provided. The sensors 300 may include, for example, infrared (IR) sensors such as active or passive IR sensors. The sensors 300 may include, for example, active microwave sensors, active ultrasonic motion sensors, and active reflective motion sensors.

In addition to the sensors 300, one or more headset motion sensors 302 such as accelerometers or gyroscopes that may be engaged with the headset 200. Additionally, or alternatively, one or more light emitting diodes (LED) 304 and/or one or more haptic feedback generators 306 such as electric heaters may be mounted on the headset 200 for purposes to be shortly disclosed. Typically, the headset includes left and right audio speakers 308. One or more processors 310 may receive signals from and send signals to appropriate components in the headset. One or more wired or wireless transceivers 312 may be provided to exchange signals with other devices.

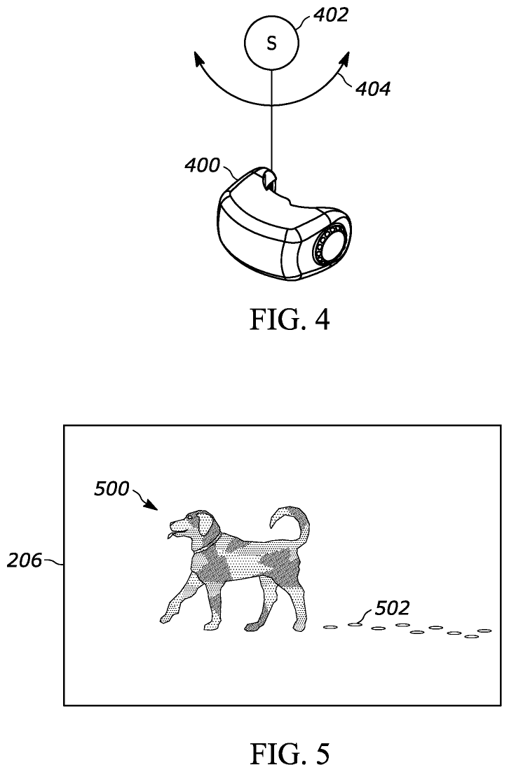

FIG. 4 illustrates an alternate headset 400 that may be substantially identical in configuration and operation to the headset 200 shown in FIGS. 2 and 3, with the following exception. Only a single thermal/motion sensor 402 may be rotatably mounted on the headset 400 for rotation or spinning as shown by the arrows 404 to scan the area around the wearer of the headset. When spinning, if the sensor, which may have a relatively small focus area, detects a heat or motion source the sensor can stop spinning and lock onto the source. The sensor may be rotated to remain locked on the source using, for example, dead reckoning as determined from a measured course and speed of the source. Rotation may be in both the horizontal and vertical planes.

FIG. 5 illustrates that when a source of heat or motion is imaged by one or more of the sensors described herein, an image 500 of the source may be presented on the display portion 206 of the headset. The image 500 may be an IR image and hence may be blurry compared to an image from a RGB camera. Note that the image 500 may be overlaid into the VR simulation being presented on the headset.

Recognizing that a moving animal or human leaves an IR trail that diminishes over time as, for example, the floor over which the heat source moves and temporarily heats through conduction cools to ambient temperature, an image 502 of such a sensed trail also may be provided on the display. The course and velocity or trajectory of the object may be determined from the heat levels of track. For example, if the heat levels of the track vary significantly it may be inferred that the speed of the object is slow, whereas if the heat levels of the track approximate that of the object itself a high speed may be inferred. The track itself indicates the course of the object. Heat level variation-to-speed may be determined by machine learning (ML) or using programmed equations.

Based on the course and velocity or trajectory, a warning may be presented on the headset as further described below to warn the wearer of an impending collision or near miss.

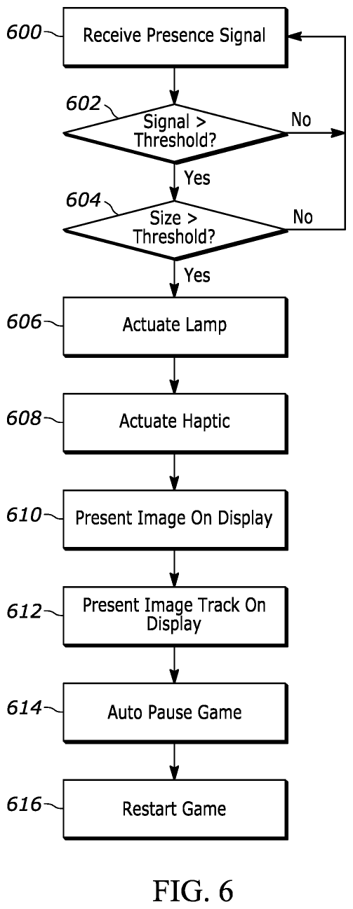

FIG. 6 illustrates example logic consistent with present principles. Commencing at state 600, a signal is received from a thermal and/or motion sensor indicating presence of a moving object and/or heat source nearby the player wearing the VR headset. In some implementations, it may be determined at decision diamond 602 whether the magnitude of the signal satisfies a threshold such that a relatively weak signal may not result in further action whereas a relatively strong signal may result in further action.

Further, in some embodiments a size threshold may also be determined at decision diamond 604, such that an object meeting a threshold size as indicated by the signal from the sensor may precipitate further action but an object not meeting the threshold size may not precipitate further action. Note that object type as inferred from the signal from the sensor also may be used such that objects only of a first type or types may precipitate further action and objects of a second type or types may not precipitate further action. FIG. 8, discussed below, illustrates a machine learning (ML)-based technique for determining object types. Note still further that, as described above, a first course of the detected object (e.g., toward the player) or first velocity of the object (e.g., high velocity) or first trajectory of the object may precipitate further action whereas a second course (e.g., away the player) or second velocity (e.g., low velocity) or second trajectory of the object may not precipitate further action.

None, some, or all of the tests described in the preceding two paragraphs may be used to precipitate further action. In any case, responsive to a presence signal at block 600 and passing the tests described above when implemented, block 606 indicates that further action precipitated by the presence of a warm and/or moving object external to the VR headset may include actuating a warning lamp on the headset, such as by blinking on and off the LED 304 shown in FIG. 3.

In addition, or alternatively, block 608 indicates that further action precipitated by the presence of a warm and/or moving object external to the VR headset may include actuating the haptic generator 306 on the headset, such as by activating a heater on the headset to indicate through heat the presence of a warm object such as an animal or a person.

In addition, or alternatively, block 610 indicates that further action precipitated by the presence of a warm and/or moving object external to the VR headset may include presenting an image of the object on the display of the headset, such as shown in FIG. 5. In addition, or alternatively, block 612 indicates that further action precipitated by the presence of a warm and/or moving object external to the VR headset may include presenting a track or trajectory of the object on the display, such as shown in FIG. 5. Note that the user interfaces discussed above may be surfaced (instantiated) based on dead reckoning to determine the track of the object in the future, such as might indicate a collision, and/or based on velocity of the object, such as a velocity satisfying a threshold.

Block 614 indicates that further action precipitated by the presence of a warm and/or moving object external to the VR headset may include automatically pausing the VR simulation being presented on the headset, starting the simulation at block 614 only when the player initiates a resume command or when the object is no longer detected.

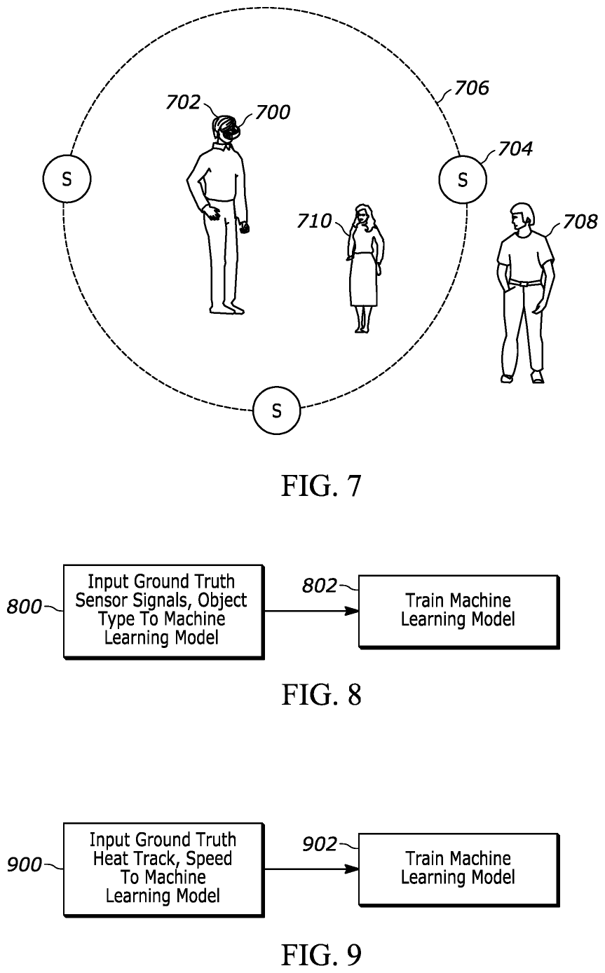

FIG. 7 illustrates an alternate embodiment in which a VR headset 700 worn by a player 702 may not include thermal and/or motion sensors, which instead may be arranged as shown at 704 around the player, distanced from the headset, to effectively establish a ‘bubble’ 706 around the player 702, interfacing wirelessly with the headset 700 to alert the player when a person or pet has entered the bubble. In other words, the sensors 704 may be oriented toward the player 702 to provide signals to the headset 700 representing an object 710 between the sensors 7-4 and the headset 700, and otherwise not provide signal representing an object 708 that is beyond the sensors 704, i.e., when the sensors are between the object 708 and the headset.

Present principles may be used in exercise applications in which thermal sensors are sensing the player and determine if the player is working hard enough such as in an exercise game, based on the magnitude of the thermal signals emanating from the player. Colors may be changed on the player's headset display as the player heat up from blue to red. The path of the arms and legs of the player also may be indicated from residual heat hysteresis as described previously, and the IR information may be tied into a pulse rate indicator on the headset. Thermal signals from the player's body can also be interpreted as virtual movement during the VR experience. For example, thermal signals can be interpreted in VR as walking, running, or jumping depending on when certain signal thresholds are met.

FIG. 8 illustrates training a ML model to learn object types based on characteristics of signals from the thermal and/or motion sensors described herein. At block 800, ground truth signals from the thermal and/or motion sensors are input along with ground truth tags of the types of objects those signals represent. The ML model is trained using the ground truth at block 802.

FIG. 9 illustrates training a ML model to learn correlations between heat levels of a moving object and velocity of the object. At block 900, ground truth signals from the thermal and/or motion sensors are input along with ground truth velocities of objects those signals represent. The ML model is trained using the ground truth at block 902.

While the particular embodiments are herein shown and described in detail, it is to be understood that the subject matter which is encompassed by the present invention is limited only by the claims.

1. An assembly, comprising:
at least one headset comprising at least one head mount wearable by a player and at least one display on the head mount for presenting virtual reality (VR) images under control of at least one processor; and
at least one heat sensor providing signals to the processor for presenting at least one indication on the headset of a source of heat external to the headset responsive to the source moving toward the headset regardless of distance to the source, the indication not being presented on the headset responsive to the source moving away from the headset regardless of distance to the source.

2. The assembly of claim 1, comprising one and only one heat sensor rotatably mounted on the headset.

3. The assembly of claim 1, comprising plural heat sensors mounted on the headset.

4. The assembly of claim 1, wherein the indication comprises a tactile indication.

5. The assembly of claim 4, wherein the tactile indication comprises heat.

6. The assembly of claim 1, wherein the indication comprises activating a lamp on the headset.

7. The assembly of claim 1, wherein the indication comprises an image of the object presented on the display.

8. The assembly of claim 1, wherein the indication comprises an image of a track of the object presented on the display.

9. The assembly of claim 1, wherein the indication is presented responsive to dead reckoning indicating a track of the object in the future.

10. The assembly of claim 1, wherein the indication is presented responsive to a velocity of the object, the object not being a wearer of the headset.

11. The assembly of claim 1, wherein the at least one sensor is distanced from the headset and oriented to provide signals to the processor representing the source of heat and/or motion external to the headset when the source is between the at least one sensor and the headset, and otherwise not provide signals to the processor representing the source of heat and/or motion external to the headset when the at least one sensor is between the source and the headset.

12. The assembly of claim 1, wherein the at least one heat sensor comprises an infrared (IR) sensor.

13. A method comprising:
receiving a signal from an infrared sensor;
based at least in part on the signal, presenting on at least one virtual reality (VR) headset an indication of a source of the signal; and
based at least in part on the signal, pausing at least one computer simulation on the VR headset.

14. A device comprising:
at least one computer storage that is not a transitory signal and that comprises instructions executable by at least one processor to:
receive a signal from a thermal sensor;
determine whether the signal indicates an object eternal to a virtual reality (VR) headset having a threshold size; and
based at least in part on the signal indicating that the object satisfies the threshold size, present an indication on the VR headset warning of the object, and based at least in part on the signal indicating that the object does not satisfy the threshold size, not present the indication.

15. (canceled)

16. The device of claim 14, wherein the instructions are executable to:
present the indication responsive to the signal having a threshold signal strength, and otherwise not present the indication.

17. The device of claim 14, wherein the instructions are executable to:
present the indication responsive to the signal indicating a source having a threshold trajectory, and otherwise not present the indication.

18. The device of claim 14, wherein the indication comprises a tactile indication.

19. The device of claim 14, wherein the indication comprises activating a lamp on the headset.

20. The device of claim 14, wherein the indication comprises an image of the object presented on the headset.

21. The device of claim 20, wherein the indication comprises an image of a track of the object presented on the display

22. The device of claim 14, wherein the indication is presented responsive to dead reckoning indicating a track of the object in the future.

23. The device of claim 14, wherein the indication is presented responsive to a velocity of the object, the object not being a wearer of the headset.
